(19) United States
(12) Patent Application Publication
(10) Pub. No.: US 2024/0368367 A1
(43) Pub. Date: Nov. 7, 2024

(54) PURIFICATION METHOD FOR RESIN SOLUTION AND PURIFIED RESIN SOLUTION

(71) Applicant: Advanced Echem Materials Company Limited, Taoyuan (TW)

(72) Inventors: HSUN-YIN KU, Taoyuan (TW); LIANG-JYI CHEN, Taoyuan (TW)

(21) Appl. No.: 18/653,989

(22) Filed: May 3, 2024

(30) Foreign Application Priority Data
May 5, 2023 (TW) 112116845

(51) Int. Cl. C08J 11/08

(52) U.S. Cl. CPC C08J 11/08; C08J 2377/02; C08J 2379/08

(57) ABSTRACT

The disclosure provides a purification method for a resin solution, including: providing a resin solution at least comprising polyimide, polyamic acid or a combination thereof, and a first organic solvent; providing high-purity water, mixing the resin solution with the high-purity water, and forming a first precipitate; separating the first precipitate; providing a second organic solvent, mixing the first precipitate with the second organic solvent, and forming a second precipitate; separating and drying the second precipitate; providing a solvent to dissolve the second precipitate, and forming a redissolved solution, the solvent at least comprising the first organic solvent; and filtering the redissolved solution. The disclosure further provides a purified resin solution.

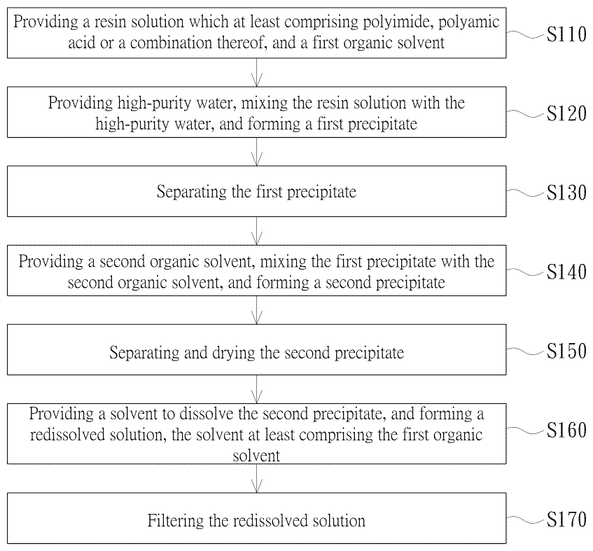

### FIELD OF THE INVENTION

The disclosure relates to a purification method for a resin solution, and more particularly to a purification method for a polyimide resin and a polyamic acid resin.

### BACKGROUND OF THE INVENTION

Since polyimide and polyamic acid have better chemical stability, arrangement controllability and friction than other organic polymers, materials based on polyimide resin and polyamic acid resin are widely used as liquid crystal arrangement materials for liquid crystal displays. The resin solution containing polyimide and polyamic acid used in liquid crystal arrangement should have satisfactory metal ion content, molecular weight distribution range, solid content and viscosity, but it is difficult for the used resin solution which is impure to be satisfactory. In addition, in order to reduce the amount of waste, there have been practices of recycling the used resin solution. However, the complicated treatment process and the use of consumables and solvents increase the cost and also produce other wastes.

### SUMMARY OF THE INVENTION

The disclosure provides a purification method for a resin solution, which is applicable to resin solutions of different types of liquid crystal display devices, has simple process and significant effect, helps in reducing the amount of waste and improves the phenomenon of declining efficacy of liquid crystal display devices after use.

The purification method for a resin solution according to the disclosure comprises the following steps: providing a resin solution at least comprising polyimide, polyamic acid or a combination thereof, and a first organic solvent; providing high-purity water, mixing the resin solution with the high-purity water, and forming a first precipitate; separating the first precipitate; providing a second organic solvent, mixing the first precipitate with the second organic solvent, and forming a second precipitate; separating and drying the second precipitate; providing a solvent to dissolve the second precipitate, and forming a redissolved solution, the solvent at least comprising the first organic solvent; and filtering the redissolved solution.

In an example of the disclosure, the step of mixing the resin solution with the high-purity water further comprises mixing the resin solution with the high-purity water in a ratio of 1:1 to 1:20.

In an example of the disclosure, the ratio of the resin solution to the high-purity water is further 1:3 to 1:10.

In an example of the disclosure, the ratio of the resin solution to the high-purity water is further 1:4 to 1:8.

In an example of the disclosure, the step of mixing the first precipitate with the second organic solvent further comprises providing the second organic solvent according to a ratio of the resin solution to the second organic solvent of 1:1 to 1:20.

In an example of the disclosure, the step of mixing the first precipitate with the second organic solvent further comprises providing the second organic solvent according to a ratio of the resin solution to the second organic solvent of 1:3 to 1:10.

In an example of the disclosure, the step of mixing the first precipitate with the second organic solvent further comprises providing the second organic solvent according to a ratio of the resin solution to the second organic solvent of 1:4 to 1:8.

In an example of the disclosure, the first organic solvent includes N-methylpyrrolidone, ethylene glycol monobutyl ether, γ-butyrolactone or a combination thereof.

In an example of the disclosure, the second organic solvent includes methanol, ethanol, isopropanol, butanol, 2-butanol, ethylene glycol, alkanes or a combination thereof.

In an example of the disclosure, the step of separating the first precipitate further comprises separating the first precipitate by filtration with a metal screen; and the step of separating the second precipitate further comprises separating the second precipitate by filtration with a metal screen.

In an example of the disclosure, the step of drying the second precipitate further includes drying the second precipitate in an environment of lower than 30° C.

In an example of the disclosure, the step of filtering the redissolved solution further includes diluting the redissolved solution with the first organic solvent before the filtration.

In an example of the disclosure, the step of filtering the redissolved solution further comprises filtering the redissolved solution with a filter membrane having a pore size of 0.1 μm to 0.2 μm.

In an example of the disclosure, the step of filtering the redissolved solution further includes forming a filtrate having a total amount of metal ions of not greater than 1 ppm.

In an example of the disclosure, an amount of any metal ion in the filtrate is less than 0.1 ppm.

In an example of the disclosure, the amount of the metal ion is further 0 ppm.

The disclosure further provides a purified resin solution prepared by the foregoing steps.

Due to use of the steps of precipitation, filtration and drying, the method of the disclosure is simple and applicable to resin solutions of different types of liquid crystal display devices. The purified resin solution has equivalent performance to the raw solution, and is applicable and reliable in liquid crystal display devices.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The FIGURE is a schematic flowchart of a purification method for a resin solution according to an example of the disclosure.

### DETAILED DESCRIPTION OF PREFERRED EMBODIMENTS

Unless otherwise defined, the raw solution in the disclosure is also called a resin raw solution, which is a resin solution that can be used in liquid crystal display devices and that has not been used. The recovered solution in the disclosure is also called a resin recovered solution or a recovered resin solution, which is a resin solution that comes from liquid crystal display devices and that has been used. The purified resin solution in the disclosure can be a resin solution obtained by purifying the recovered solution or a raw solution.

An example of the disclosure provides a purification method for a resin solution. The resin solution can be a material that is used in or comes from liquid crystal display devices, and further, can be a material used for liquid crystal arrangement in liquid crystal display devices. Preferably, the purified resin solution obtained in the example of the disclosure contains polyimide, polyamic acid or a combination thereof. The purification method of the example of the disclosure makes the viscosity and solid content of the resin solution reach expected values and be satisfactory. It has been further proved through a liquid crystal cell electrical test that the purified resin solution is applicable and reliable in liquid crystal display devices.

Referring to the FIGURE, the purification method of the example of the disclosure comprises steps S110 to S170. Step S110: providing a resin solution which at least comprising polyimide, polyamic acid or a combination thereof, and a first organic solvent. Step S120: providing high-purity water, mixing the resin solution with the high-purity water, and forming a first precipitate. Step S130: separating the first precipitate. Step S140: providing a second organic solvent, mixing the first precipitate with the second organic solvent, and forming a second precipitate. Step S150: separating and drying the second precipitate. Step S160: providing a solvent to dissolve the second precipitate, and forming a redissolved solution, the solvent at least comprising the first organic solvent. Step S170: filtering the redissolved solution.

In a preferred example of the disclosure, the resin solution in step S110 is a material for liquid crystal arrangement recovered from liquid crystal display devices. In addition to the polyimide, the polyamic acid and the first organic solvent, the recovered resin solution, which is a resin solution that has been used, usually contains other foreign matters or contains the matter of which the content deviates from the acceptable range, making the resin recovered solution impure and affecting the efficacy of the resin solution in liquid crystal display devices. For example, the amount of metal ions in the resin recovered solution may exceed the standard value of the amount of metal ions in the resin raw solution. Excess small molecules in the recovered solution is also one of the reasons for the impurity. In addition, compared with the raw solution, the water content, viscosity and solid content of the resin recovered solution may deviate from the standard values.

The first organic solvent can vary depending on the type of the recovered resin solution, and moreover, can be a single organic solvent or a combination of multiple organic solvents. For example, the resin solution can be recovered from VA, IPS or TN liquid crystal display devices, so the resin recovered solution can refer to the resin solution recovered from, for example, VA, IPS or TN liquid crystal display devices. In some examples of the disclosure, the first organic solvent includes, for example, N-methylpyrrolidone, ethylene glycol monobutyl ether, γ-butyrolactone or a combination thereof.

The high-purity water in step S120 can be, for example, pure water. In the example of the disclosure, the high-purity water is preferably ultrapure water, and more preferably, has a resistance value of less than 18 M ohm. A weight ratio of the resin recovered solution to the high-purity water is 1:1 to 1:20, preferably 1:3 to 1:10, more preferably 1:4 to 1:8. In some examples of the disclosure, the mixing can be carried out, for example, in an agitating tank. In addition, the mixing can further be carried out, for example, in a temperature-controlled agitating tank made of stainless steel. After the recovered solution and the high-purity water are thoroughly mixed according to the ratio, a mixed solution is formed. Step S120 further includes allowing the mixed solution to stand for precipitation. Polymers such as polyimide and polyamic acid are precipitated as main components of the first precipitate. The standing time is preferably not more than 60 min. Other substances originally present in the recovered solution, including organic and inorganic molecules and ions, may be dissolved or suspended in water in step S120.

In step S130, the first precipitate can be separated by, for example, filtration with a filter. The filter can have a screen preferably having a pore size of 3 to 20 μm. If the screen is made of metal, the metal is preferably SUS316 stainless steel or titanium alloy or a higher grade material. In addition, the metal screen can further be made of a porous metal material. In some examples of the disclosure, the first precipitate is separated by filtration with a porous titanium screen. The first precipitate obtained by the separation can be used in step S140.

In step S140, further, the second organic solvent in a certain weight range is provided according to the amount of the recovered solution in step S110 to be mixed with the first precipitate. A weight ratio of the recovered solution to the second organic solvent is 1:1 to 1:20, preferably 1:3 to 1:10, more preferably 1:4 to 1:8. In some examples of the disclosure, the second organic solvent can be, for example, methanol, ethanol, isopropanol, butanol, 2-butanol, ethylene glycol, alkanes or a combination thereof. The mixed solution is allowed to stand for precipitation. Polymers such as polyimide and polyamic acid are precipitated as main components of the second precipitate. Other substances originally present in the recovered solution, including organic and inorganic small molecules and ions, may be dissolved or suspended in the second precipitate in step S140. In addition, the mixing in step S140 may take away water remaining in the first precipitate.

For the separation of the second precipitate in step S150, reference can be made to step S130. The second precipitate obtained by the separation can be naturally dried at room temperature, but preferably dried in an environment of lower than 30° C. In some examples of the disclosure, the drying can be carried out, for example, in a vacuum oven. The dried second precipitate may be in the form of powder. The drying is completed when the weight of the second precipitate no longer changes.

The solvent in step S160 can be provided according to the amount of the recovered solution in step S110. For example, the solvent can be provided according to a volume ratio of components in the recovered solution (i.e., a volume ratio of the solute to the solvent) in step S110 until the proportion of the solvent in the redissolved solution is the same as that in the recovered solution in step S110. The solvent used includes the first organic solvent. In some examples of the disclosure, the redissolution can be carried out, for example, in a temperature-controlled agitating tank.

In step S170, the redissolved solution can be filtered, for example, with a filter membrane. The filter membrane preferably has a pore size of 0.1 μm to 0.2 μm to further remove foreign matters having a particle size of more than 0.2 μm. The purified resin solution obtained after steps S110 to S170 may have equivalent components, viscosity, solid content and physical and chemical properties to the resin raw solution, and can be directly used in liquid crystal display devices. The purified resin solution is further tested, as shown in Tables 1 to 5 and Examples 1 to 4 below.

TABLE 1
Test items and test devices

| Test item | Device |
|---|---|
| Viscosity | Viscosimeter |
| Solid content | Infrared moisture meter |
| Amount of metal ions | ICP-MS |
| Voltage Holding Ratio | LCD characteristics measurement |
| | system |
| Ion density | LCD characteristics measurement |
| | system |
| Image sticking | Spectrometer |

In some examples of the disclosure, the test items can be further be tested using, for example, a TOKI SANGYO TVEL-25L viscosimeter, a METLER TOLEDO 204HX infrared moisture meter, an ICP 350D ICP-MS, a TOYO 6254 LCD characteristics measurement system and an Otsuka electronics LCD 5200 spectrometer.

### Example 1: Physical and Chemical Properties of Purified Resin Solution of IPS Liquid Crystal Display Devices

In this example, the resin recovered solution of IPS liquid crystal display devices and the purified resin solution of IPS liquid crystal display devices are tested for their viscosity, solid content and amount of metal ions and compared with the resin raw solution for IPS liquid crystal display devices. The results are shown in Table 2.

TABLE 2

| | Resin raw | | Resin recovered | | Purified resin | |
|---|---|---|---|---|---|---|
| | solution | | solution | | solution | |
| Viscosity | First test | 42.0 | First test | 84.5 | First test | 42.8 |
| (mPas) | Second test | 41.9 | Second test | 78.4 | Second test | 45.2 |
| | Third test | 41.5 | Third test | 84.3 | Third test | 44.8 |
| Solid | First test | 6.98 | First test | 8.44 | First test | 7.18 |
| content | Second test | 7.01 | Second test | 7.88 | Second test | 7.19 |
| (%) | Third test | 7.00 | Third test | 8.13 | Third test | 7.07 |
| Amount | First test | Na: 0.006 | First test | Na: 0.034 | First test | Na: 0.004 |
| of metal | | K: 0.003 | | K: 0.005 | | K: 0.000 |
| ions | | Cu: 0.002 | | Cu: 0.005 | | Cu: 0.000 |
| (ppm) | | Fe: 0.000 | | Fe: 0.005 | | Fe: 0.000 |
| | Second test | N/A | Second test | Na: 0.011 | Second test | Na: 0.002 |
| | | | | K: 0.084 | | K: 0.001 |
| | | | | Cu: 0.008 | | Cu: 0.001 |
| | | | | Fe: 0.000 | | Fe: 0.001 |
| | Third test | N/A | Third test | Na: 0.011 | Third test | Na: 0.002 |
| | | | | K: 0.084 | | K: 0.001 |
| | | | | Cu: 0.008 | | Cu: 0.000 |
| | | | | Fe: 0.000 | | Fe: 0.000 |

Table 2 shows that after the resin solution is purified, the viscosity, solid content and amount of metal ions decrease to the ranges of the viscosity, solid content and amount of metal ions of the resin raw solution. The total amount of metal ions is not greater than 1 ppm, and the amount of any metal ion is less than 0.1 ppm. In some examples of the disclosure, the amount of any metal ion may further be less than 0.01 ppm, preferably 0.002 ppm or below. Due to the decrease in the viscosity, solid content and amount of metal ions, it is apparent that the purified resin solution contains no or almost no other foreign matters, and it can be expected to have equivalent performance to the resin raw solution.

### Example 2: Electrical Properties of Liquid Crystal Cell of Purified Resin Solution of IPS Liquid Crystal Display Devices

In this example, the resin recovered solution of IPS liquid crystal display devices and the purified resin solution of IPS liquid crystal display devices are tested for actual performance in a liquid crystal cell and compared with the resin raw solution for IPS liquid crystal display devices. The results are shown in Table 3.

TABLE 3

| | Resin raw | Purified resin |
|---|---|---|
| | solution | solution |
| Voltage Holding Ratio | 87.4 | 84.5 |
| (VHR, %) | | |
| Ion density | 15.2 | 16.4 |
| (pC/cm²) | | |
| Image sticking/60° C./2 h | 0.41 | 0.46 |
| (%) | | |

Table 3 shows that the purified IPS resin solution can have equivalent performance to the resin raw solution in terms of VHR, ion density and image sticking.

### Example 3: Physical and Chemical Properties of Purified Resin Solution of TN Liquid Crystal Display Devices

In this example, the resin recovered solution of TN liquid crystal display devices and the purified resin solution of TN liquid crystal display devices are tested for their viscosity, solid content and amount of metal ions and compared with the resin raw solution for TN liquid crystal display devices. The results are shown in Table 4.

TABLE 4

| | Resin raw | | Resin recovered | | Purified resin | |
|---|---|---|---|---|---|---|
| | solution | | solution | | solution | |
| Viscosity | First test | 24.6 | First test | 126.0 | First test | 27.9 |
| (mPas) | Second test | 24.1 | Second test | 103.0 | Second test | 28.1 |
| Solid | First test | 5.75 | First test | 7.80 | First test | 5.71 |
| content | Second test | 5.72 | Second test | 7.50 | Second test | 5.72 |
| (%) | | | | | | |
| Amount | First test | Na: 0.083 | First test | Na: 0.011 | First test | Na: 0.095 |
| of metal | | K: 0.024 | | K: 0.060 | | K: 0.005 |
| ions | | Cu: 0.000 | | Cu: 0.000 | | Cu: 0.000 |
| (ppm) | | Fe: 0.000 | | Fe: 0.000 | | Fe: 0.000 |
| | Second test | N/A | Second test | N/A | Second test | N/A |

Table 4 shows that after the TN resin solution is purified according to the example of the disclosure, the viscosity, solid content and amount of metal ions decrease to the ranges of the viscosity, solid content and amount of metal ions of the resin raw solution. The total amount of metal ions is not greater than 1 ppm, and the amount of any metal ion is less than 0.1 ppm. In some examples of the disclosure, the amount of any metal ion may further be less than 0.01 ppm. Due to the decrease in the viscosity, solid content and amount of metal ions, it is apparent that the purified resin solution contains no or almost no other foreign matters, and it can be expected to have equivalent performance to the resin raw solution.

### Example 4: Electrical Properties of Liquid Crystal Cell of Purified Resin Solution of TN Liquid Crystal Display Devices

In this example, the resin recovered solution of TN liquid crystal display devices and the purified resin solution of TN liquid crystal display devices are tested for actual performance in a liquid crystal cell and compared with the resin raw solution for TN liquid crystal display devices. The results are shown in Table 5.

TABLE 5

| | Resin raw | Purified resin |
|---|---|---|
| | solution | solution |
| Voltage Holding Ratio | 85.4 | 84.0 |
| (VHR, %) | | |
| Ion density | 12.6 | 13.4 |
| (pC/cm²) | | |
| Image sticking/60° C./2 h | 0.45 | 0.51 |
| (%) | | |

Table 5 shows that the purified TN resin solution can have equivalent performance to the resin raw solution in terms of VHR, ion density and image sticking.

As can be seen from Examples 1 to 4, the purification method example of the disclosure is applicable to resin solutions of different types of liquid crystal display devices, and can make these resin solutions have equivalent performance to the raw solution. Therefore, the purification method can improve the phenomena of decrease in voltage holding ratio, increase in ion density and increase in probability of image sticking in liquid crystal display devices due to the use of the impure resin solution, and help in reducing the amount of waste.

The disclosure further provides a purified resin solution, which has equivalent viscosity, solid content and amount of metal ions to the raw solution and also has equivalent performance to the raw solution in terms of voltage holding ratio, ion density and image sticking.

The purified resin solution provided in the example of the disclosure comprises polyimide, polyamic acid or a combination thereof, and a first organic solvent. The first organic solvent includes N-methylpyrrolidone, ethylene glycol monobutyl ether, γ-butyrolactone or a combination thereof. Further, the purified resin solution can be, for example, a purified resin solution of IPS liquid crystal display devices or a purified resin solution of TN liquid crystal display devices. In some examples, the purified resin solution of IPS liquid crystal display devices may have a viscosity of 15 to 65 mPas and a solid content of 3.5 to 9.0%, and preferably, have a viscosity of 35 to 50 mPas and a solid content of 4 to 8%. In some examples, the purified resin solution of TN liquid crystal display devices may have a viscosity of 15 to 70 mPas and a solid content of 4 to 8%, and preferably, have a viscosity of 15 to 35 mPas and a solid content of 4 to 7.5%. The purified resin solution of the disclosure is preferably prepared by steps S110 to S170 described above. In the purified resin solution provided by the example of the disclosure, a total amount of metal ions may be not greater than 1 ppm, and an amount of any metal ion may be less than 0.1 ppm.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A purification method for a resin solution, comprising:
providing a resin solution, the resin solution at least comprising polyimide, polyamic acid or a combination thereof, and a first organic solvent;
providing high-purity water, mixing the resin solution with the high-purity water, and forming a first precipitate;
separating the first precipitate;
providing a second organic solvent, mixing the first precipitate with the second organic solvent, and forming a second precipitate;
separating and drying the second precipitate;
providing a solvent to dissolve the second precipitate, and forming a redissolved solution, the solvent at least comprising the first organic solvent; and
filtering the redissolved solution.

2. The purification method for a resin solution according to claim 1, wherein the step of mixing the resin solution with the high-purity water further comprises mixing the resin solution with the high-purity water in a ratio of 1:1 to 1:20.

3. The purification method for a resin solution according to claim 2, wherein the ratio of the resin solution to the high-purity water is further 1:3 to 1:10.

4. The purification method for a resin solution according to claim 3, wherein the ratio of the resin solution to the high-purity water is 1:4 to 1:8.

5. The purification method for a resin solution according to claim 1, wherein the step of mixing the first precipitate with the second organic solvent further comprises providing the second organic solvent according to a ratio of the resin solution to the second organic solvent of 1:1 to 1:20.

6. The purification method for a resin solution according to claim 5, further comprising providing the second organic solvent according to a ratio of the resin solution to the second organic solvent of 1:3 to 1:10.

7. The purification method for a resin solution according to claim 6, further comprising providing the second organic solvent according to a ratio of the resin solution to the second organic solvent of 1:4 to 1:8.

8. The purification method for a resin solution according to claim 1, wherein the first organic solvent includes N-methylpyrrolidone, ethylene glycol monobutyl ether, γ-butyrolactone or a combination thereof.

9. The purification method for a resin solution according to claim 1, wherein the second organic solvent includes methanol, ethanol, isopropanol, butanol, 2-butanol, ethylene glycol, alkanes or a combination thereof.

10. The purification method for a resin solution according to claim 1, wherein the step of separating the first precipitate further comprises separating the first precipitate by filtration with a metal screen; and the step of separating the second precipitate further comprises separating the second precipitate by filtration with a metal screen.

11. The purification method for a resin solution according to claim 1, wherein the step of drying the second precipitate further includes drying the second precipitate in an environment of lower than 30° C.

12. The purification method for a resin solution according to claim 1, wherein the step of filtering the redissolved solution further includes diluting the redissolved solution with the first organic solvent before the filtration.

13. The purification method for a resin solution according to claim 1, wherein the step of filtering the redissolved solution further comprises filtering the redissolved solution with a filter membrane having a pore size of 0.1 μm to 0.2 μm.

14. The purification method for a resin solution according to claim 1, wherein the step of filtering the redissolved solution further includes forming a filtrate having a total amount of metal ions of not greater than 1 ppm.

15. The purification method for a resin solution according to claim 14, wherein an amount of any metal ion in the filtrate is less than 0.1 ppm.

16. The purification method for a resin solution according to claim 15, wherein the amount of the metal ion is further 0 ppm.

17. A purified resin solution, prepared by the following steps:
providing a recovered resin solution, the recovered resin solution at least comprising polyimide, polyamic acid or a combination thereof, and a first organic solvent;
providing high-purity water, mixing the recovered resin solution with the high-purity water, and forming a first precipitate;
separating the first precipitate;
providing a second organic solvent, mixing the first precipitate with the second organic solvent, and forming a second precipitate;
separating and drying the second precipitate;
providing a solvent to dissolve the second precipitate, and forming a redissolved solution, the solvent at least comprising the first organic solvent; and
filtering the redissolved solution.

18. The purified resin solution according to claim 17, further having a viscosity of 15 to 70 mPas and a solid content of 3.5 to 9.0%.

19. The purified resin solution according to claim 17, wherein the first organic solvent includes N-methylpyrrolidone, ethylene glycol monobutyl ether, γ-butyrolactone or a combination thereof.

20. The purified resin solution according to claim 17, having a total amount of metal ions of not greater than 1 ppm.
